(19) United States
(12) Patent Application Publication
(10) Pub. No.: US 2012/0213898 A1
(43) Pub. Date: Aug. 23, 2012

(54) ATTRACTIVE FORCE PACKING

(75) Inventor: Jasna Brujic, New York, NY (US)

(73) Assignee: New York University

(21) Appl. No.: 13/398,684

(22) Filed: Feb. 16, 2012

Related U.S. Application Data
(60) Provisional application No. 61/463,561, filed on Feb. 18, 2011.

(51) Int. Cl. A23D 7/00; A23C 13/00

(52) U.S. Cl. 426/285; 426/531; 426/601; 426/586

(57) ABSTRACT

Methods, compositions and systems having a first set of materials and a second set of material. The second material provides an attractive force between components of the first set of materials. The composition comprising the first and second material having one or more predetermined properties selected from the group consisting of material coordination, material distribution, density and porosity.

### CROSS-REFERENCE TO RELATED PATENT APPLICATIONS

This application claims priority to U.S. Provisional Patent Application No. 61/463,561, filed Feb. 18, 2011 and is incorporated herein by reference in its entirety.

The present invention relates to a method and system for using a predetermined amount of a depletant, or other mechanisms of particle attraction such as chemical and magnetic methodologies, to act on a collection of particles to achieve at least one of a selectable particle coordination number, particle distribution, particle density or porosity for an article of manufacture or composition.

### BACKGROUND OF THE INVENTION

The random packing of particles is a problem of great practical and theoretical importance with applications to systems as diverse as granular materials, emulsions and colloids. How athermal particles pack is affected by many parameters, including the packing protocol, the shape and roughness of the particles, as well as their polydispersity. Nevertheless, experiments and numerical simulations have suggested the existence of reproducible disordered packing structures, which can be achieved by sedimenting and shaking monodisperse (Scott, G D (1960) Packing of spheres. Nature 188:908-909; Finney, J L (1970) Random packings and the structure of simple liquids. I. the geometry of random close packing. Proc. Roy. Soc. Lond. A 319:479-493.) and polydisperse (Clusel, M, Corwin, E I, Siemens, AON, Bruji'c, J (2009) A ‘granocentric’ model for random packing of jammed emulsions. Nature 460:611-615.) spheres, ellipsoids (Man, W et al. (2005) Experiments on random packings of ellipsoids. Phys. Rev. Lett. 94:198001.) and tetrahedra (Jaoshvili, A, Esakia, A, Porrati, M, Chaikin, P M (2010) Experiments on the random packing of tetrahedral dice. Phys. Rev. Lett. 104:185501.). For frictional particles, there emerges a reversible packing density curve from random loose packing (“RLP”) to random close packing (“RCP”) as a function of the applied tapping protocol (Nowak, E R, Knight, J B, Povinellli, M L, Jaeger, H M, Nagel, SR (1997) Reversibility and irreversibility in the packing of vibrated granular material. Powder Technology 94:79-83). The dependence of density of jammed states on the friction coefficient has led to an equation of state and a prediction of a jamming phase diagram to describe the behavior of these systems in numerical simulations (Song, C M, Wang, P, Makse, H A (2008) A phase diagram for jammed matter. Nature 453:629-632). Moreover, experiments on compressible two-dimensional packings of photoelastic beads (Majmudar, T S, Sperl, M, Luding, S, Behringer, R P (2007) Jamming transition in granular systems. Phys. Rev. Lett. 98:058001) and foams (Katgert, G, van Hecke, M (2010) Jamming and geometry of two-dimensional foams. EPL 92:34002) have probed configurations at different packing densities by applying an external load. The reproducibility of all these jammed states for a given set of experimental conditions suggests that a statistical mechanics framework may apply to these inherently out of equilibrium systems (Edwards, SF, Oakeshott, RBS (1989) Statistical mechanics of powder mixtures. Physica A 157:1091-1100; Song, C M, Wang, P, Makse, H A (2005) Experimental measurement of an effective temperature for jammed granular materials. Proc. Natl. Acad. Sci. 102:2299-2304; Henkes, S, Chakraborty, B (2009) Statistical mechanics framework for static granular matter. Phys. Rev. E 79:061301). Other studies have argued that the history dependence and heterogeneities in the packing preclude a general theory of jammed granular matter (Torquato, S, Truskett, T M, Debenedetti, P G (2000) Is random close packing of spheres well defined? Phys. Rev. Lett. 84:2064-2067; O'Hern, C S, Langer, S A, Liu, A J, Nagel, S R (2001) Force distributions near jamming and glass transitions. Phys. Rev. Lett. 86:111-114).

### SUMMARY OF THE INVENTION

This invention is concerned with a method and system for establishing controllable and predictable packing of materials. In one embodiment, the packing involves a phase change to a jammed state. The invention may, in certain embodiments, comprise packing athermal, frictionless spheres under gravity in the presence of a short-range attractive force (such as by an electric field, physical, chemical or magnetic forces). By examining the packing geometry in 3D we find that the strength of a selected attractive interaction among particles controls the packing density and the microstructure of jammed states. Whereas friction in granular systems introduces tangential forces into the locally jammed configurations to stabilize loose structures with fewer contacts (Alexander, S (1998) Amorphous solids: their structure, lattice dynamics and elasticity. Phys. Rep. 296:65-236.), attractive forces play an analogous role via a different mechanism. When two particles almost touch under the force of gravity, the presence of short range attraction introduces normal forces between the centers of neighboring spheres, which serve to mechanically stabilize otherwise inaccessible local configurations. The experimental distributions of local packing properties are in very good agreement with the theoretical predictions of recent models originally developed for repulsive particle aggregates: the ‘granocentric’ model (Clusel, M, Corwin, E I, Siemens, A O N, Bruji'c, J (2009) A ‘granocentric’ model for random packing of jammed emulsions. Nature 460:611-615) and the ‘k-gamma distribution’ of the local packing fraction (Aste, T, Matteo, T D (2008) Emergence of gamma distributions in granular materials and packing models. Phys. Rev. E 77:021309). This result extends the range of applicability of geometrical modeling and statistical mechanics approaches to capture the effects of both attraction and polydispersity. Furthermore, the dependence of packing properties on the level of attraction provides a new way to measure compactivity from the microstructure and, thus, explore the jamming phase diagram as a function of global parameters.

Jamming attractive athermal particles under gravity should not be confused with the widely studied gel transition in thermal systems, where classical thermodynamics applies (Bibette, J, Mason, T G, Gang, H, Weitz, D A (1992) Kinetically induced ordering in gelation of emulsions. Phys. Rev. Lett. 69:981-984; Lu, P J et al. (2008) Universal gelation of particles with shortranged attraction. Nature 453:499-504; Pham, K N, Egelhaaf, S U, Pusey, P N, Poon, WCK (2004) Glasses in hard spheres with short-range attraction. Phys. Rev. E 69:011503). The absence of thermal fluctuations localizes the effect of attraction to the first shell of neighbors where the forces due to gravity and attraction balance to form a mechanically stable pack. Despite the fundamental differences between thermal and athermal systems, this one important similarity had now been noted. Namely, a reentrant behavior of packing density with attraction, analogous to that observed in thermal glassy systems, thus questioning its postulated dynamical origin. Indeed, at the onset of attraction the static packings reach densities higher than random close packing of the repulsive frictionless system. The existence of such states has been proposed numerically, but they have never been observed experimentally. The microscopic characterization of attractive packings therefore opens the way to new analogies between granular materials and glasses.

It remains an open question whether statistical mechanics approaches apply to random packings of athermal particles. While a jamming phase diagram has recently been proposed for hard spheres with varying friction, one embodiment of the present invention uses a frictionless emulsion system in the presence of various forces (such as depletion, chemical and magnetic) to sample the available phase space of packing configurations. Using confocal microscopy we access their packing microstructure and test the theoretical assumptions. As a function of attraction, our packing protocol under gravity leads to well-defined jammed structures in which global density initially increases above random close packing and subsequently decreases monotonically. Microscopically, the fluctuations in parameters describing each particle, such as the coordination number, number of neighbors and local packing fraction, are for all attractions in excellent agreement with a local stochastic model, indicating that long range correlations are not important. Furthermore, the distributions of local cell volumes can be collapsed onto a universal curve using the predicted k-gamma distribution, in which the shape parameter k is fixed by the polydispersity while the effect of attraction is captured by resealing the average cell volume. Within the Edwards statistical mechanics framework, this result measures the decrease in compactivity with global density, which represents a direct experimental test of a jamming phase diagram in athermal systems. The success of these theoretical tools in describing yet another class of materials gives support to the much-debated statistical physics of jammed granular matter.

### BRIEF DESCRIPTION OF THE DRAWINGS

FIG. 1: (a) 3D representation of confocal images of an attractive emulsion packing in which the force of attraction [symbol] F_{d} [symbol] =19 pN. Droplets are fluorescently labeled with Nile Red dye and refractive index matched with the aqueous phase for transparency. Images are taken using a 63× oil immersion lens with a field of view of 65 μm in the xy plane. The 2D confocal slices and their reconstructed images are shown for repulsive (b, c) and attractive (d, e) packings. Ticks indicate two examples of the original spheres in the images and those found by the Fourier transform particle tracking algorithm. Navigation maps (white lines) are superimposed with the reconstructed packing (c, e) to identify cells belonging to particles. This mapping attributes each voxel of void space to the particle whose surface is closest to it. It unambiguously identifies neighbors, contacts and cell volumes. As a function of attraction, the packings become looser and exhibit voids shown in (d). These voids appear to occupy cells in the navigation map because particles above and below the confocal plane share void space in the third dimension.

FIG. 2: Probability density distributions of the local quantities P(n) in (a), P(z) in (b), P(φ_{loc}) in (c) and P(δₑₓₚ) in (d) are shown as a function of [symbol] F_{d} [symbol] while the insets present the dependency of the corresponding average values. The legend in (a) defines the symbols for all data sets, which are used throughout this application. Panel (a) shows that P(n) and the increase in [symbol] n [symbol] with the central particle radius are independent of attraction. By contrast, P(z) in (b) and P(φloc) in (c) shift to lower values as a function of attraction since looser packings are formed. This observation is corroborated by the broadening in the distribution of surface to surface distances between neighboring particles P(δₑₓₚ) in (d). Interestingly, repulsive emulsion packings at F_{d}=0 indicate a turnover in the observed trends. All distributions are fitted very well by the granocentric model (dashed lines), whose parameters are shown in the inset in (d) and explained in the text.

FIG. 3: (a) Evolution of P(V) and its cumulative distribution for different levels of attraction. Notice that V is resealed by the volume of the average particle for each distribution. The distributions shift to larger volumes as a function of attraction. The data are fit with the shifted Γ distribution in Eq. 1 and compared to the monodisperse case. (b) Data collapse is observed when V is resealed by the shifted average volume of the cell [symbol] V [symbol] −Vₘᵢₙ. This resealing implies that the shape parameter k remains constant with attraction. The inset shows that the compactivity χ decreases with increasing density φ, which is consistent with the observed decrease in [symbol] V [symbol] . The RCP point curiously does not have the lowest compactivity.

FIG. 4: The global trend in the average coordination number versus density maps out an equation of state for polydisperse packings at different levels of attraction. The resulting curve lies below the theoretical RLP line for monodisperse frictional spheres at infinite χ. This is to be expected since polydisperse packings occur at higher densities (as indicated by the shift in the polydisperse RCP point). Moreover, our packings exhibit a decrease in χ with density, such that they necessarily probe the phase diagram below the limit of infinite χ.

### DETAILED DESCRIPTION OF PREFERRED EMBODIMENTS

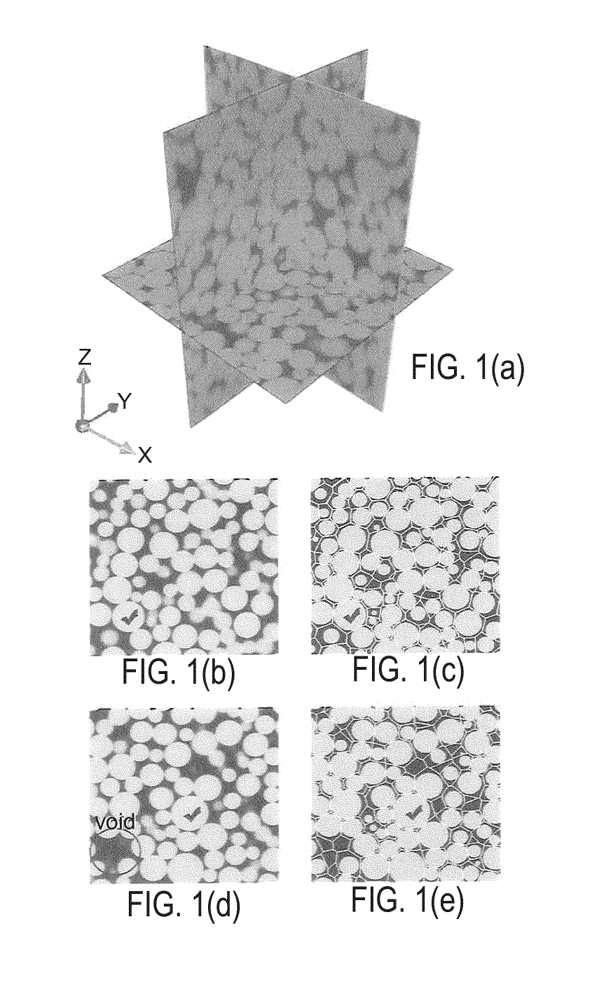

Characterization of Jammed Packings. In one embodiment to create an example of a jammed packing, athermal oil-in-water is used. Because the oil droplets are less dense than the continuous phase, they pack at the top surface by the buoyancy force—a process known as creaming. In addition, in a preferred embodiment an attractive interparticle force is introduced by varying the concentration of the depletant sodium dodecyl sulfate (SDS) micelles, as explained in the Materials and Methods section. To image the static attractive packings we use confocal microscopy (see Materials and Methods) and a typical 3D representation is shown in FIG. 1a. The two-dimensional slices of repulsive and attractive jammed packings, shown in FIGS. 1b, d respectively, reveal that the presence of high enough attraction gives rise to voids within the packing. The packing structures and their navigation maps in FIGS. 1c, e (see Materials and Methods) are constructed to measure the number of contacts per particle, i.e. the coordination number, z, the number of neighbors, n, a particle shares an interface with and the local packing fraction, φ_{loc}, which is the ratio between the particle volume, Vₚ, and the volume of the corresponding cell, V. The global density, φ, is determined by the total volume of the particles divided by the system volume.

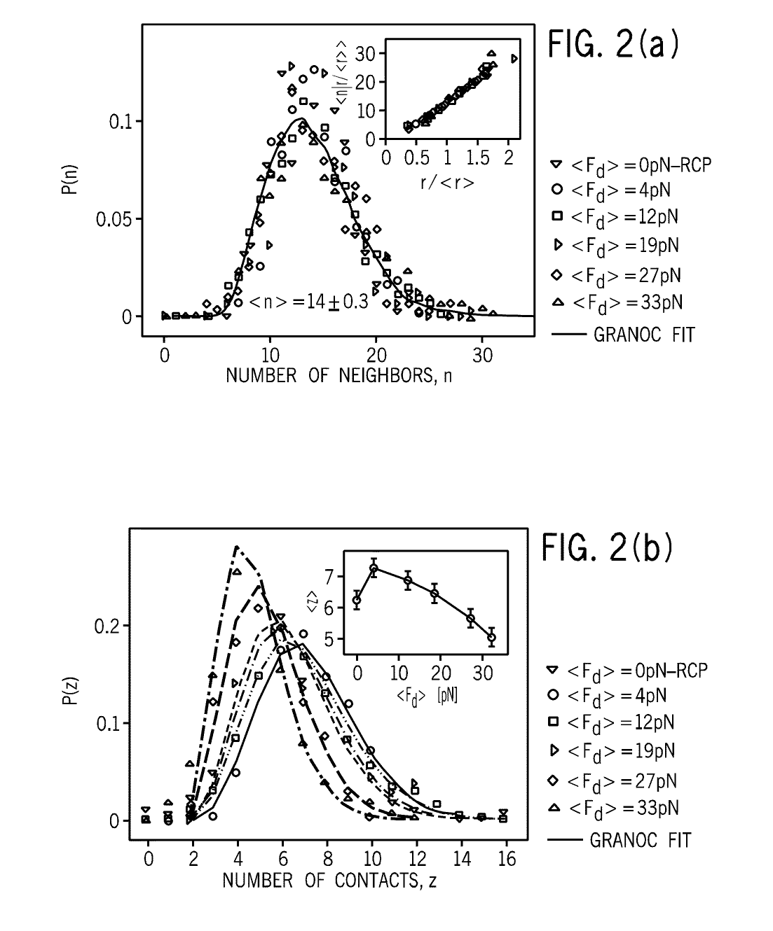

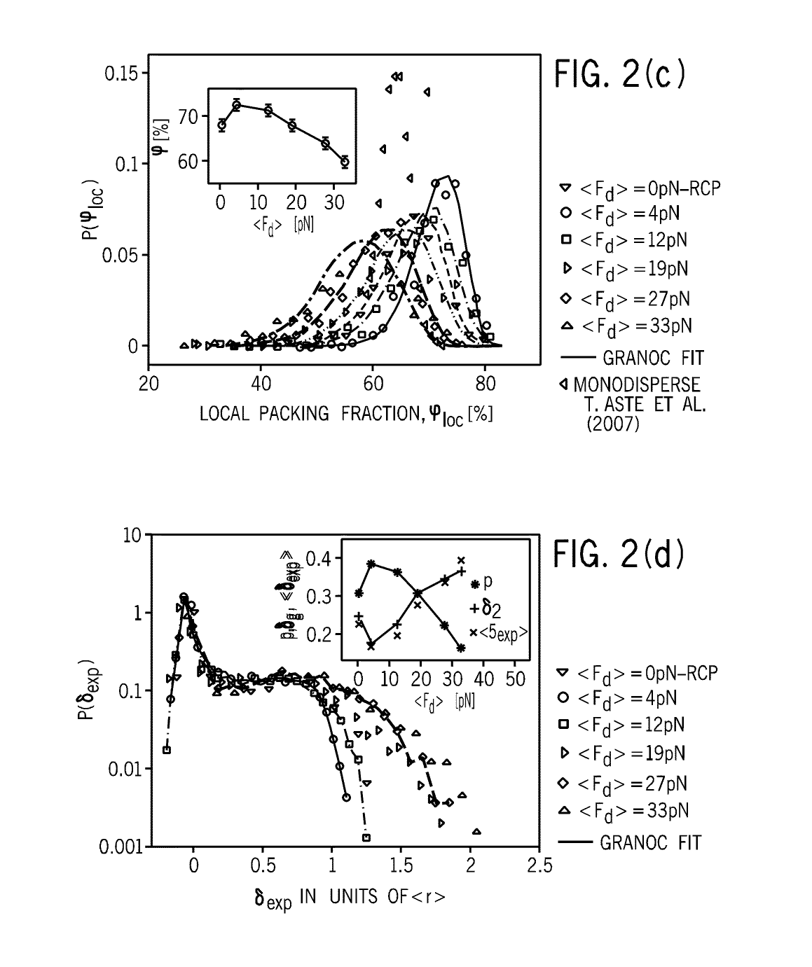

Trends in Packing Properties with Attraction. FIG. 2 presents the probability density distributions of the local parameters z, n, and φ_{loc} as a function of attraction. Even though the packings exhibit more void space as the attraction is increased, the neighbor number distribution P(n) shown in FIG. 2a, is independent of attraction. Just as in the repulsive packings, the [symbol] n [symbol] is 14±0.3 with a standard deviation of 30%. This makes sense because the navigation map partitions the extra void space between the neighbors, but the number of common interfaces remains the same. The inset shows that the particle size dependence on the number of neighbors also remains the same for all attractions, rendering the number of neighbors an insensitive measure of the packing structure.

The coordination number z reports on the number of force-bearing particles in the mechanically stable packing, which is greatly affected by the attractive forces in addition to gravity. The measured distributions P(z) in FIG. 2b peak at decreasing values from 7 to 4 and become narrower as a function of attraction. The isostatic condition predicts a value of [symbol] z [symbol] =6 for repulsive frictionless spheres in 3D, yet the inset in FIG. 2b shows that [symbol] z [symbol] decays as a function of [symbol] F_{d} [symbol] to below the isostatic limit. This is possible because attractive forces allow one to locally stabilize structures with fewer than 4 contacts by creating loops and arches. With increasing attraction the probability of such local configurations also increases, as shown in the P(z), thus shifting [symbol] z [symbol] Analogously, the distribution of local packing fraction P(φ), shown in FIG. 2c, shifts towards lower packing densities with wider distributions as a function of increasing attraction. The decrease in global density φ is also apparent in the inset. Although the trends with attraction are clear, the data set obtained for repulsive packings at RCP reveals interesting anomalies in the local and global quantities.

An initial increase in [symbol] z [symbol] above isostaticity and φ above RCP at the onset of attraction is shown in the insets of FIGS. 2b, and 2c to be significantly larger than the error bars on the measurements. It is difficult to obtain more points in the turnover region since the CMC occurs at 13 mM SDS, the weakest attraction of F_{d}=4 pN is measured at 15 mM SDS, and the precision on the measurements is ±2 mM. Nevertheless, the point at RCP is based on three different samples imaged in 5 different regions of 1500 droplets each, such that the error bar quoted in the figure suggests that the reentrant transition is real. Since the deformation at such low forces has a negligible effect on the density, the answer must lie in the accessible configurations. While jammed random states above RCP have been proposed geometrically, this is the first athermal experimental system to explore such compact configurations that avoid crystallization. Interestingly, a similar turnover in φ versus F_{d} has been observed in attractive thermal gels undergoing structural arrest and interpreted as the signature of a reentrant glass transition. In our case, this turnover implies that isostatic packings with a density at RCP can also be achieved with a nonzero attractive potential, as shown by the F_{d}=0 points and those at 19 pN in both insets in FIGS. 2b, c. Even though their global quantities [symbol] z [symbol] and φ are the same to within experimental error, we next explore the packing microstructure in search of deviations in their local configurations.

In order to characterize the local configurations of each particle we measure the surface to surface distances δₑₓₚ between a central particle and its neighbors. Those neighbors that are in contact with the central particle have a δₑₓₚ≦0, while the non-contacting neighbors exhibit a distribution of δₑₓₚ that depends on the positions of the particles. In FIG. 2d we show the distribution P(δₑₓₚ) for all levels of attraction. They exhibit a peak in the distribution below δₑₓₚ=0 (signifying contacts) and a broad shoulder for the non-contacting neighbors situated at least 0.8 [symbol] r [symbol] away from the surface. As a function of the applied range of attraction between 4 and 33 pN this tail broadens to reach values of interparticle distances as large as 2 [symbol] r [symbol] , which explains the general decrease in global density. This trend is also reflected in the increasing average values of [symbol] δₑₓₚ [symbol] shown in the inset. Interestingly, the two data sets at RCP and F_{d}=19 pN with the same global quantities [symbol] z [symbol] and φ show significant differences in the P(δₑₓₚ). The distribution for the 19 pN data set displays a shift in the peak towards shorter distances and a much broader tail than that of the RCP packing. In other words, the probability of finding both tighter and looser structures is higher in the attractive than the repulsive case, which is a surprising structural distinction between packings with the same global properties.

Modeling of Local Fluctuations. To understand the observed statistical trends quantitatively, we interpret the data using the granocentric local model introduced earlier to fit P(n), P(z), and P(φ_{loc}). This model assumes two independent random processes—the filling of space around each particle with neighbors and the subsequent choice of contacts among them to ensure mechanical stability. The inputs of the model are the experimental values of [symbol] n [symbol] , [symbol] z [symbol] (excluding particles with z≦3), and global density φ and the outputs are the distance δ_{g} between two neighboring sphere surfaces, as well as the distributions P(n), P(z), and P(φ_{loc}), shown in FIGS. 2a, b, c. In the inset in FIG. 2d, the ratio of contacts to neighbors, given by p=( [symbol] z [symbol] −3)/( [symbol] n [symbol] −3) is shown to decrease as a function of the attractive force due to the decrease in [symbol] z [symbol] , while the predicted distance δ_{g} naturally increases as the packings become looser and agrees very well with the average experimental values [symbol] δₑₓₚ

[symbol]

Further confidence in the model is shown in FIGS. 2a, 2b, and 2c by the agreement between the measured distributions and the theoretical predictions in which all parameters are fixed by experimentally determined values. Note that we do not include rattlers—particles that would move under infinitesimal shear, when fitting the granocentric model to P(z). The proportion of rattlers in the system changes the average coordination number to within the error in the image analysis and is therefore negligible in terms of the trend induced by attraction. It is surprising that this stochastic grain-centered model captures all the probability distributions, since it assumes that there are no local correlations between neighboring particles nor long range correlations beyond the first shell of neighbors. This result is in contrast to the structure of attractive colloidal gels, where the fractal dimension indicates correlations between thermal particles that persist throughout the system.

Statistical Mechanics of Attractive Polydisperse Packings. Given the success of the local granocentric description of the packing structure, we next consider the fluctuations in the volume V of each cell in the navigation map in terms of a statistical mechanics framework. Since the total volume of the packing Vₜₒₜ is fixed, the navigation map partitions Vₜₒₜ into N volumes V each one belonging to a particle. Independently picking volumes V from a uniform distribution between a minimum volume Vₘₘ, fixed by the smallest particle, and Vₘₐₓ=Vₜₒₜ−NVₘᵢₙ results in an exponential probability distribution of volumes P(V) in the thermodynamic limit. This Boltzmann-type distribution maximizes the entropy given the constraints. Assuming that each cell V is made of k elementary cells, this distribution becomes a shifted k-gamma distribution with a shape parameter k and a scale parameter [symbol] V [symbol] −Vₘᵢₙ:

$$P ( V ) - \frac{{k}^{k}}{Γ ( k )} \frac{{( V - {V}_{m i n} )}^{( k - 1 )}}{{( 〈 V 〉 - {V}_{m i n} )}^{k}} exp ( - k \frac{V - {V}_{m i n}}{〈 V 〉 - {V}_{m i n}} ) . \qquad [ 1 ]$$

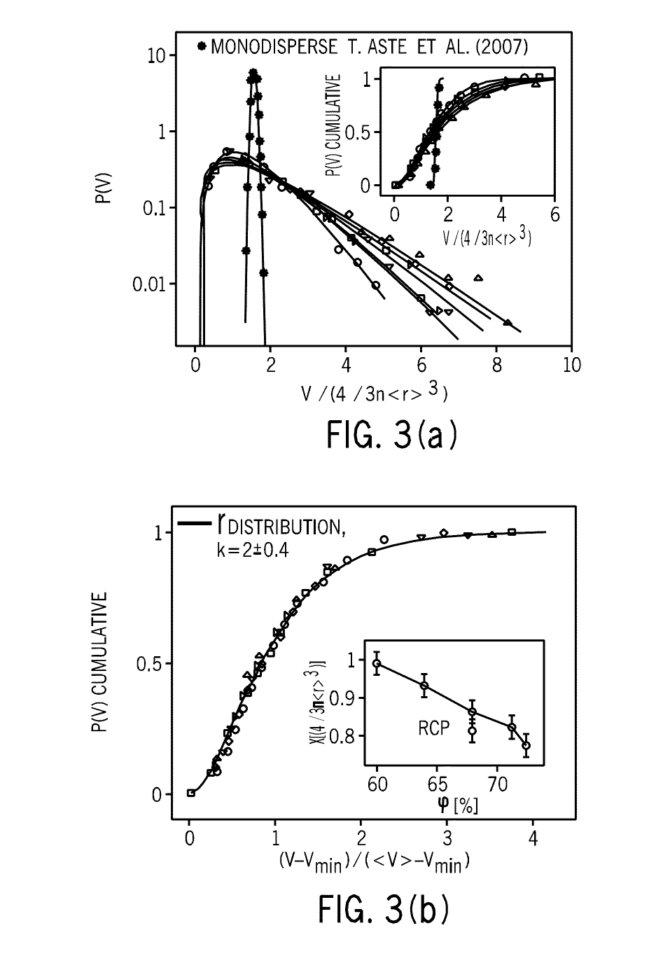

Indeed, a wide range of packings with different packing protocols and global densities have been successfully fit by this type of distribution. Here we investigate the effect of polydispersity and subsequently attraction on P(V). FIG. 3a shows that polydispersity of 25% alone significantly broadens the distribution compared to the previously measured monodisperse case (star symbols) and shifts the global packing fraction to a higher value. If this effect were simply the result of a convolution of the monodisperse P(V) with the distribution of particle volumes, rescaling each V by the volume of the particle itself would lead to exactly the same distributions P(φ_{loc}) for the mono and polydisperse cases, shown in FIG. 2c. However, even the resealed polydisperse distribution remains broader, indicative of an additional source of randomness to the size distribution. Within the statistical mechanics framework, the volume V replaces the energy E and the compactivity χ is the analogue of temperature T. Since k is the derivative d [symbol] V [symbol] /dχ, it is equivalent to the specific heat in thermal systems. Fitting the mono and polydisperse cases with k≈14 and k≈2, respectively, captures the observed changes in shape and width of P(V) in FIG. 3a. This means that polydispersity lowers the specific heat as fewer random variables are needed to define the volumes, thus approaching the Boltzmann distribution with maximum entropy.

As a function of attraction, FIG. 3a shows an increase in both [symbol] V [symbol] and the standard deviation σ of the distributions, as expected from the looser packing structures. Since Eq. (1) gives ( [symbol] V [symbol] −Vₘᵢₙ)/σ=\sqrt{k}, this dependence leads to a constant value of k=2.0±0.4 for all levels of attraction. This is shown in FIG. 3b by the data collapse that results from rescaling the volumes as (V−Vₘᵢₙ)/( [symbol] V [symbol] −Vₘᵢₙ).

Within the thermodynamic framework, a simple counting argument of volumes leads to a definition of the entropy S and consequently an expression for the inverse compactivity χ⁻¹=∂S/∂Vₜₒₜ in granular statistical mechanics. The resulting expression for χ=( [symbol] V [symbol] −Vₘᵢₙ)/k is shown to be linearly decreasing with density in the inset in FIG. 3b. By comparison, compressed packings of 2D foams exhibit an increase in k with density, which leads to a sharper decrease in χ. Since χ is a measure of the ability to compact the system further, it makes sense that looser packings result in higher values of χ and have a higher entropy.

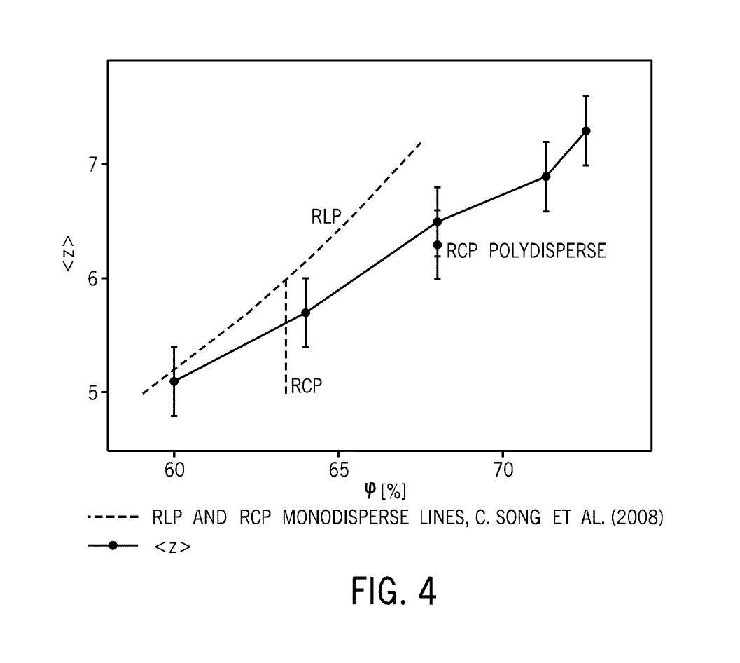

Recently, a phase diagram for jammed matter has been proposed in terms of the dependence of χ and [symbol] z [symbol] on density for monodisperse frictional hard spheres. Since polydisperse packings pack more efficiently than monodisperse ones, the RLP-RCP lines are shifted to higher densities. Moreover, the theoretical RLP line is determined for infinite χ. Since the measured χ in our packings is decreasing with density, the values of [symbol] z [symbol] we obtain at different densities cannot be directly compared with those at infinite χ. For these reasons, our data shown in FIG. 4 lie below the predicted RLP line at infinite χ (dash-point line), which we have extended beyond the monodisperse RCP density of 64% for comparison with the polydisperse packings in the figure. These measurements therefore map out the predicted phase diagram for our particular experimental protocol and system, in which packings denser than RLP are achieved over the same range of [symbol] z [symbol] consistent with the fact that we explore states with decreasing values of χ. Surprisingly, we extend the limits of the phase diagram to hyperstatic packings up to [symbol] z [symbol] =7.5 and densities up to 74%, which is above the RCP density (68% in the polydisperse case).

### Materials and Methods

Depletion Attraction Forces. The depletion energy has an entropic origin and its dependence on the surfactant concentration is derived in reference and validated for our emulsion system in. Therefore the depletion attraction force between two spheres of radii r₁ and r₂ whose centers are a distance L apart is given by

$${F}_{d} = 2 π {P}_{m} {r}_{1} {r}_{2} \frac{d - ( L - {r}_{1} - {r}_{2} )}{{r}_{z} + {r}_{2}} \qquad [ 2 ]$$

if (L−r₁−r₂)<d and F_{d}=0 otherwise. Here d is the micelle diameter and Pₘ=k_{B}Tnₘ is the depletant pressure, where nₘ is the depletant concentration, k_{B} is the Boltzmann constant and T is the temperature. Given that the linear size of the micelles is approximately 500 times smaller than the size of the smallest emulsion droplet, and that the micelle volume fraction is always below 2% it is adequate to model the depletant pressure as that of an ideal gas.

We calculate F_{d} at an equilibrium distance L of around 10 nm and using a critical micellar concentration (CMC) of 13 mM. The average depletion force [symbol] F_{d} [symbol] for each packing is defined as the force between two droplets of average radius [symbol] r [symbol] =3.5 μm. Since the particle size distribution has a 25% standard deviation in radius, the depletion force between particle pairs picked at random and calculated using Eq. 2 has a distribution with a standard deviation of ±20%. Note that the average attraction force increases significantly more than the spread of each distribution. The maximum force of [symbol] F_{d} [symbol] =33 pN is set by the saturation point of SDS (i.e. 50 mM). This range is 10 to 100 times stronger than the weight of a single particle and corresponds to small deformations of 1-10 Δ, such that the spherical approximation holds.

Confocal Imaging and Analysis. In a preferred embodiment, the protocol to prepare the jammed packing sample involves creaming a very dilute emulsion at a density φ≈5% to avoid clustering and aggregation of the particles. Refractive index matching between the droplets and the aqueous phase allows us to image the dynamics of the packing process in real time and investigate the resulting structure in 3D using a fast scanning confocal microscope (Leica TCS SP5 II). The droplets deposit onto the surface one by one and subsequently slide, roll and stick until they are locally jammed. Once the packing of ≈1500 droplets is formed, a box of volume 65×65×100 μm several particles away from the boundaries of a 1 mL container is imaged in the confocal microscope. The voxel size is 130 nm in the horizontal xy plane and 300 nm in the vertical z direction.

We analyze the structures in terms of the particle positions and radii with subvoxel accuracy using a Fourier transform algorithm. We then use the geometrical overlaps in the reconstructed spheres to identify particles that are in contact. This allows us to measure the number of contacts a particle has, i.e. its coordination number, z. The error in estimating particle positions and radii translates to an error of ±0.3 in the [symbol] z [symbol] estimation. To characterize the local neighborhood of each particle we tessellate space using the navigation map shown in FIGS. 1c, e. This mapping defines the number of neighbors, n, the local packing fraction, φ_{loc}, and the volume of every cell, V.

In other embodiments of the invention other inert polymers useful as depletants can include polyethylene glycol or micelles of surfactants such as np7 tergitol. That is, numerous surface active agents, or surfactants, both ionic and non-ionic can be used to implement the method and articles of manufacture of the invention. Such methodologies enable achievement of a selectable number and type of contacts per particular particle, as well as selectable density or porosity and selectable particle distributions with particular coordination and type of particle. This method thus provides a system to create predetermined useful particle arrangements by controlling packing properties by adjusting attraction between particles. Broadening size distribution makes packing denser while attraction can make them selectively looser than repulsive packing.

As mentioned hereinbefore, the mechanism for establishing particle attraction forces, can extend to a variety of other forces, such as, but not limited to, electric field, chemical and magnetic forces. For example, instead of a depletion force, one can use homophillis proteins (e.g., cadherins) which stick to one another upon contact. The stickiness of a particle (i.e., the extent of attraction) determines the properties of the packing such as, for example, density, number of contacts, number of neighbors, size of the pores. Also complimentary DNA strands can be disposed on a droplet or particle which then are attached to each other to effectuate the method and article of manufacture of the invention. The kinetics of each category of force will be somewhat different; but as one of ordinary skill would understand, these can be adjusted to enable achieving the desired particle distribution with selected density and particle coordination.

The various methods and articles of manufacture also can be tuned and adjusted by use of other methods such as sedimentation (or creaming) under gravity. Hereinbefore is described a method for depletion induced attraction in an emulsion system where droplets cream under gravity. The methods using the techniques described herein, are more general and apply in particular to all spherical particulate systems that are large enough that thermal energy is irrelevant (i.e. larger than 1 micrometer at room temperature). Particles thus attract one another once they are brought in close proximity to each other (by use of various forces, such as, magnetic particles, latex beads with specific attractive chemistry between them and spherical grains that attract due to capillary forces). This makes the method and system applicable not only to emulsions, relevant for the food, cosmetics and pharmaceutical industries, but also to hard particles found in paints, or to granular materials found in the oil industry. Controlling attraction therefore permits control of the physical properties listed above in a variety of systems. The applications of these properties to industry are diverse and include:

1. Density can be used to tune the mechanical properties of a packing, i.e. the texture of a cream—the denser the packing the thicker the cream;

2. Density can control the drying rate of paints, which in turn determines its sheen;

3. Density can control the amount of active ingredient in a product such as a cream or a pharmaceutical powder in a pill;

4. The connectivity or number of contacts controls the conductivity of a packing of electrically conducting particles, e.g. graphite; and

5. The connectivity controls the rigidity of a packing, i.e. its resistance to shear or other forms of stress.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A material composition comprising:
a first set of materials;
a second material which provides an attractive force between components of the first set of materials;
the material composition having one or more predetermined properties selected from the group consisting of material coordination, material distribution, density and porosity.

2. The composition of claim 1 wherein the second material comprises a depletant.

3. The composition of claim 2 wherein the depletant is sodium dodecyl sulfate

4. The composition of claim 1 wherein the second material includes at least one of an electric field component, a magnetic component or a chemical component.

5. The composition of claim 1 wherein the first set of materials comprises particles.

6. The composition of claim 5 wherein the first set of materials comprises attractive particles.

7. The composition of claim 5, wherein the first set of materials form a granular material comprising discrete solid particles.

8. The composition of claim 5 wherein there is a jamming of attractive athermal particles under gravity.

9. The composition of claim 1 wherein the composition is an emulsion.

10. The composition of claim 1 wherein the composition is edible.

11. The composition of claim 1 wherein the composition is a cream.

12. The composition of claim 1, wherein the composition is polydisperse.

13. A method of making a composition having packed particles comprising:
providing a first group of particles;
adding a predetermined amount of a second group of particles to the first group of particles, the second group of particles endowing the first group of particles with an attraction force between adjacent particles of the first group of particles; and
spacing the collection of the particles to achieve at least one of a selectable density, selectable porosity selectable particle coordination, and selectable particle size distribution for the composition
wherein the composition undergoes a jamming transition to the jammed state.

14. The method as defined in claim 13 further including an initial step of identifying a predetermined end distribution of the particles and adjusting the attractive force to achieve the predetermined end distribution.

15. The method as defined in claim 13 further comprising tuning at least one property of the particle composition to adjust packing of the particles.

16. The method of claim 13, wherein the second group of particles endow attractive force by chemical bonding.

17. The method of claim 13, wherein the second group of particles are depletants and endow attractive force by depletion forces.

18. The method of claim 13, wherein one or more of the second group of particles are bound to each particle of the first group of particles and the attractive force is further between the particles of the second group.

19. A method of controlling packing of a composition comprising:
manipulating depletion forces within the composition; and
tuning at least one property of the particle composition by the manipulation of the depletion forces, the at least one property selected from the group consisting of particle coordination, particle distribution, density and porosity.

20. The method of claim 19, wherein manipulating the depletion forces comprises altering one or more property selected from the group consisting of depletant concentration, temperature, and pressure.

21. The method of claim 19, wherein a phase transition to a jammed state occurs in the composition.
